(19) United States
(12) Patent Application Publication
(10) Pub. No.: US 2019/0018395 A1
(43) Pub. Date: Jan. 17, 2019

(54) METHOD FOR DESIGN OF A MANUFACTURING PROCESS USING AN INTERERENCE AND CLEARANCE DATABASE

(71) Applicant: GM GLOBAL TECHNOLOGY OPERATIONS LLC, Detroit, MI (US)

(72) Inventors: Arkadi Vinnik, Ann Arbor, MI (US); John B. Katona, JR., Holly, MI (US); Paul S. Hornung, Shelby Township, MI (US)

(73) Assignee: GM GLOBAL TECHNOLOGY OPERATIONS LLC, Detroit, MI (US)

(21) Appl. No.: 15/646,921

(22) Filed: Jul. 11, 2017

(51) Int. Cl. G05B 19/418

(52) U.S. Cl. CPC G05B 19/41865; G05B 2219/31342

(57) ABSTRACT

A method for designing a designing a product manufacturing process has been developed. First, a final manufacturing assembly is loaded into a manufacturing process design engine. Next, clearance and interference checks are performed for all objects used during the manufacturing process with an interference and clearance calculation engine. The checks are based on data retrieved from an interference and clearance database (ICD). If an interference or inadequate clearance is detected by the design engine, the manufacturing operation is redesigned. If no interference or inadequate clearance is detected, the manufacturing operation is optimized with a manufacturing process optimization engine. The product manufacturing process is finalized once the optimization is complete.

### TECHNICAL FIELD

The technical field generally relates to manufacturing processes, and more particularly relates to designing a manufacturing process using an interference and clearance database.

### INTRODUCTION

Manufacturing is continually becoming more sophisticated reflecting the drive to reduce size, weight and therefore, cost of products while maintaining and improving quality. For example, the typical architecture in the automotive industry utilizes over 2500 hex fasteners (i.e., screws, bolts, nuts). Coupling these vast numbers of fasteners with a myriad of unique constrained access scenarios can be a cumbersome task to design an efficient manufacturing process and select the proper tool.

Accordingly, it is desirable to use an interference and clearance database to design a manufacturing process. Furthermore, other desirable features and characteristics of the present invention will become apparent from the subsequent detailed description and the appended claims, taken in conjunction with the accompanying drawings and the foregoing technical field and background.

### SUMMARY

A method is provided for designing a product manufacturing process. In one embodiment, the method includes: loading a final assembly into a manufacturing process design engine; performing interference and clearance checks for objects used during the manufacturing process with an interference and clearance calculation engine, where the interference and clearance checks are based on data retrieved from an interference and clearance database (ICD); redesigning an assembly operation if an interference or inadequate clearance is detected by the process design engine; optimizing the assembly operation with a manufacturing process optimization engine if an interference or inadequate clearance is not detected by the process design engine; and finalizing the manufacturing process once optimization is complete.

A method is provided for creating an interference and clearance database (ICD) for a manufacturing process. In one embodiment, the method includes: loading dimensions for all available objects for possible use in the manufacturing process into an interference and clearance calculation engine, wherein the dimensions of the available objects are retrieved from computer-aided design (CAD) models; loading the dimensions for all product variations in the manufacturing process into the interference and clearance calculation engine, wherein the dimensions of the product variations are retrieved from the CAD models; loading the work position for assembly of every combination of tools and fasteners for possible use in during the manufacturing process into the interference and clearance calculation engine; calculating any interference and inadequate clearance of each possible combination of objects, products and work positions in the manufacturing process with the clearance calculation engine; determining possible alternative work positions for all object interferences and inadequate clearance detected by the clearance calculation engine; disregarding objects for use in the manufacturing process if no possible alternative work positions for the interference or inadequate clearance are determined; and adding each combination of object, product variation and work positions to the ICD if no interference or inadequate clearance for the combination is detected by the interference and clearance calculation engine.

### BRIEF DESCRIPTION OF THE DRAWINGS

The exemplary embodiments will hereinafter be described in conjunction with the following drawing figures, wherein like numerals denote like elements, and wherein:

FIG. 1 is a flowchart showing a method for creating an interference and clearance database (ICD) for a manufacturing process in accordance with an embodiment;

FIG. 2 is a is a flowchart showing a method for designing and optimizing a manufacturing process utilizing a TCD as shown in FIG. 1 in accordance with an embodiment; and

FIGS. 3a-3d are diagrams illustrating a method for designing and optimizing a manufacturing process utilizing an ICD in accordance with an embodiment.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description.

A method for designing a manufacturing a manufacturing process using an interference and clearance database has been developed. The tool clearance database contains information pertaining to clearances between all vehicle parts, all relevant variations of tools (hand, cutting, robotic, etc.) and all relevant positions and postures of human workers during the manufacturing process. The method optimizes the manufacturing process by minimizing the costs of tools and equipment, minimizing process time and optimizing ergonomic actions of human workers. The method allows the design and verification of the manufacturing process by performing batch calculations on all possible combinations of tools, fasteners and work positions to determine tool clearances.

In one embodiment, the method calculates: all possible locations, positions and postures of human workers; all possible combinations of tools available during the manufacturing process including tool extensions and sockets; and all possible combinations of fasteners used during the manufacturing process. The method then calculates clearances for all tool combinations used within a final manufacturing and records these clearances into a database down to the level of individual part occurrences. Additionally, ergonomic and positioning clearances are calculated for both human and robotic tools for the entire final manufacturing. Each of the clearances are saved in an interference and clearance database (ICD) for later retrieval and batch processing.

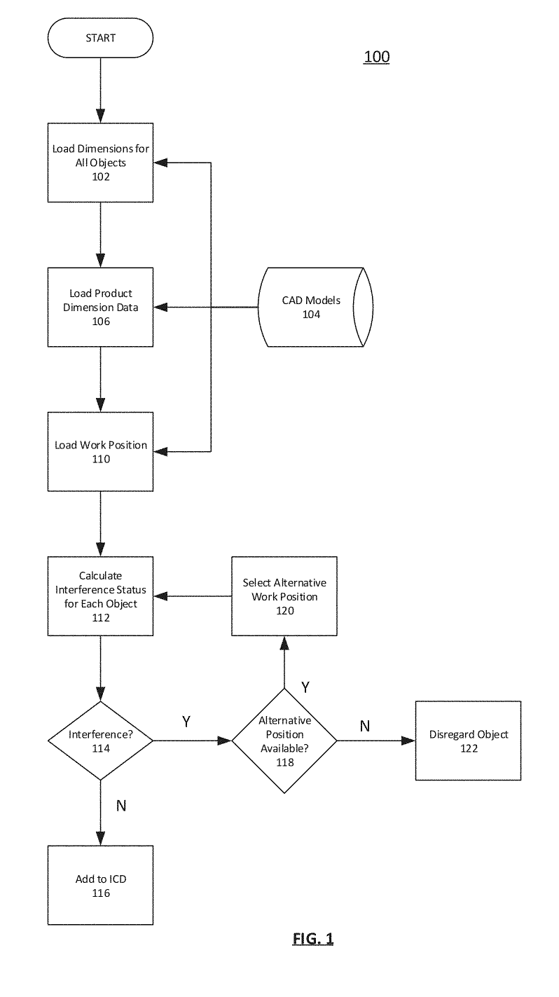

Turning now to FIG. 1, a flowchart is shown depicting a method for utilizing an ICD for all analysis and design of a manufacturing process 100 in accordance with one embodiment. The method may be used for all stages of the manufacturing process (initial, intermediate and final). First, the geometry and dimensions for all available tools, fixtures, human models, robots, automated guided vehicle (AGV), etc. for possible use in the manufacturing process are loaded into an interference and clearance calculation engine 102. The tools may include hand tools for use by human worker with various extensions and sockets. The tools may also include cutting, welding, machining or robotic tools. The dimensions and other data regarding all possible objects used in the manufacturing process are retrieved from computer-aided design (CAD) models 104. The CAD models are typically stored in product lifecycle management (PLM) and product data management (PDM) databases.

Next, the dimensions for all variations of the product in all stages a manufacturing are loaded into the interference and clearance calculation engine 106. This includes data on fasteners, disposable materials and other objects required for the manufacturing process. The information regarding the dimensions are retrieved from CAD models stored on PLM and PDM databases 104. Finally, the work positions for every combination of tools, fixtures and fasteners for every possible use during the product manufacturing process are loaded into the interference and clearance calculation engine 110. The work positions include data for assembly, welding, machining and all other manufacturing activities. Additionally, work positions for in-process assemblies (IPA) may be loaded as well. All possible work positions for human workers, robots and AGV's are included. The information regarding the work positions are retrieved from CAD models stored on PLM and PDM databases 104.

Once the data regarding the objects, product variations and work positions is loaded, the interference and clearance calculation engine will calculate the clearance of all possible combination and variation of objects, product variations and work positions in the manufacturing process 112. If the engine determines an interference exists 114, it will attempt to identify any alternative work positions, objects, tools or fasteners that will accomplish the individual manufacturing operation. For each alternative available, the interference and clearance calculation engine will repeat the clearance analysis 120. If no alternative is available, the tool will be disregarded and not used in the manufacturing process 122. Once each possible combination of tools, fasteners and work positions is analyzed, the combinations that have adequate clearance will be added to the ICD 116.

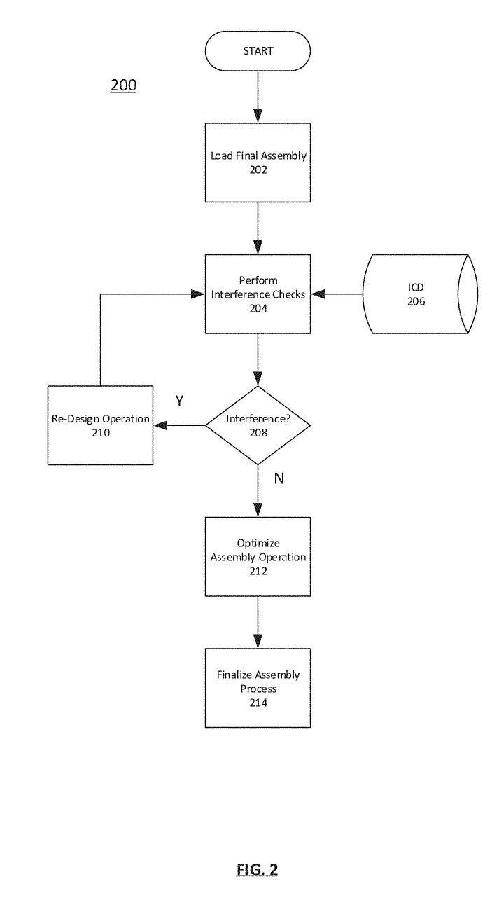

Turning now to FIG. 2 with continued reference to FIG. 1, a flow chart is shown depicting a method for designing and optimizing a manufacturing process utilizing an ICD 200 as shown in FIG. 1 in accordance with an embodiment. First, all variants of a final manufactured assembly are loaded into a manufacturing process design engine 202. IPAs (work in-process) may be loaded if necessary. Next, clearance and interference checks for all objects including tools are performed for each IPA that makes up the final assembly 204. The clearance checks are performed based on information retrieved from the ICD 206 as described previously with reference to FIG. 1. If an interference or near miss is detected 208, the manufacturing process is redesigned by either selecting an alternative tool, fastener or work position for either a robot tool or human worker 210. Once all clearances are resolved, a manufacturing process optimization engine optimizes each IPA 212. The optimization may include the selection of the most efficient tools, the most efficient motion of tools, the most efficient ergonomic position for human worker, the quickest manufacturing time for robotic tool or other similar improvements to the manufacturing operation. Once the IPAs have been optimized, the process design engine finalizes the manufacturing process by verifying the final assembly is complete.

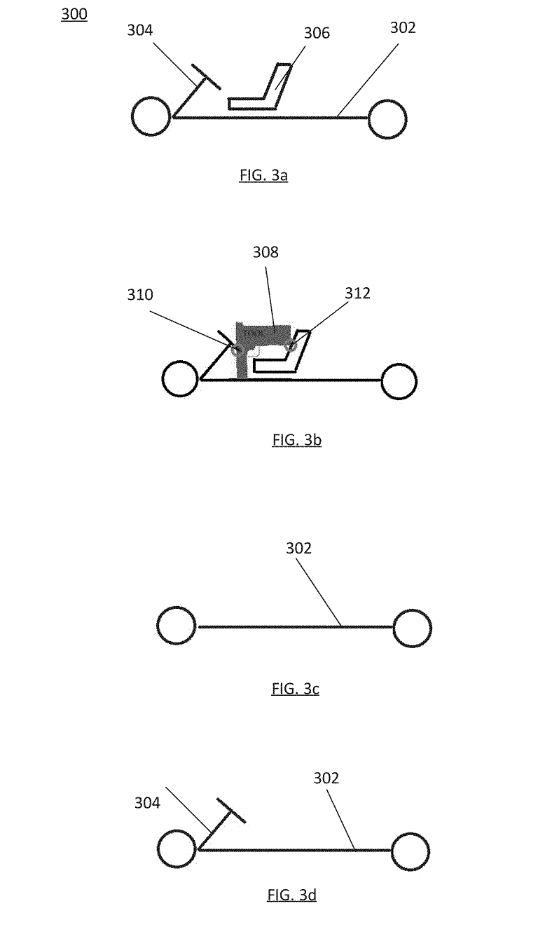

Turning now to FIG. 3a-3d with continued reference to FIGS. 1 and 2, diagrams are shown illustrating a method for designing and optimizing a manufacturing process utilizing an ICD in accordance with an embodiment. FIG. 3a shows a vehicle final assembly 300 that includes a vehicle frame 302, a steering column 304 and a vehicle seat assembly 306. In the embodiment shown in FIG. 3b, the clearance calculation engine detects an interference between the tool 308 and the assembly operations at two points: at the steering column 310; and at the vehicle seat assembly 312. As shown in FIG. 3c, the clearance calculation engine finds no interference for the assembly operation of the vehicle frame 302 and this will be saved in the ICD. As shown in FIG. 3d, the clearance calculation engine finds an interference for the assembly operation of the steering column 304 and subsequently search for an alternative work position for this operation. Once an alternative is determined to have no interference, the alternative will be saved in the ICD.

Some of the advantages of embodiments of the present method include quickly and instantaneously verifying the feasibility of a manufacturing process during design. The method has the scalable ability to quickly determine the best tools to perform manufacturing operations. It provides instant design verification on the impact to the manufacturing processes. It should be clear that other advantages of the embodiments of the present method include: optimizing the number of tools and tool combinations; optimizing the sequence of motion of the tools used in the manufacturing process; optimizing the ergonomic position of human workers; and optimizing the position of robots and other mechanisms to decrease manufacturing time.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for designing a product manufacturing process, comprising:
loading a final assembly into a manufacturing process design engine;
performing interference and clearance checks for objects used during the manufacturing process with an interference and clearance calculation engine, where the interference and clearance checks are based on data retrieved from an interference and clearance database (ICD);
redesigning an assembly operation if an interference or inadequate clearance is detected by the process design engine;
optimizing the assembly operation with a manufacturing process optimization engine if an interference or inadequate clearance is not detected by the process design engine; and
finalizing the manufacturing process once optimization is complete.

2. The method of claim 1, wherein the objects comprise tools.

3. The method of claim 2, wherein the tools include tool extensions.

4. The method of claim 1, wherein the objects comprise fixtures.

5. The method of claim 1, wherein the objects comprise robots.

6. The method of claim 1, wherein redesigning an assembly operation comprises implementing an alternative work position for the assembly operation.

7. The method of claim 6, wherein the alternative work position comprises utilization of an alternative tool.

8. The method of claim 6, wherein the alternative work position comprises utilization of an alternative ergonomic position for a human worker.

9. The method of claim 6, wherein the alternative work position comprises utilization of an alternative position for a robotic tool.

10. The method of claim 1, wherein optimizing an assembly operation comprises determining the most efficient motion of tools.

11. The method of claim 1, wherein optimizing an assembly operation comprises determining the most efficient ergonomic position for a human worker.

12. The method of claim 1, wherein optimizing an assembly operation comprises determining the quickest assembly time for a robotic tool.

13. The method of claim 1, wherein finalizing the manufacturing process comprises verification of a design of the manufacturing process.

14. A method for creating an interference and clearance database (ICD) for a manufacturing process, comprising:
loading dimensions for all available objects for possible use in the manufacturing process into an interference and clearance calculation engine, wherein the dimensions of the available objects are retrieved from computer-aided design (CAD) models;
loading the dimensions for all product variations in the manufacturing process into the interference and clearance calculation engine, wherein the dimensions of the product variations are retrieved from the CAD models;
loading the work position for assembly of every combination of tools and fasteners for possible use in during the manufacturing process into the interference and clearance calculation engine;
calculating any interference and inadequate clearance of each possible combination of objects, products and work positions in the manufacturing process with the clearance calculation engine;
determining possible alternative work positions for all object interferences and inadequate clearance detected by the clearance calculation engine;
disregarding objects for use in the manufacturing process if no possible alternative work positions for the interference or inadequate clearance are determined; and
adding each combination of object, product variation and work positions to the ICD if no interference or inadequate clearance for the combination is detected by the interference and clearance calculation engine.

15. The method of claim 14, wherein the available objects comprise tools.

16. The method of claim 14, wherein the available objects comprise fixtures.

17. The method of claim 14, wherein the available objects comprise robots.

18. The method of claim 14, wherein the available objects comprise human models.

19. The method of claim 15, wherein the available objects comprise automated guided vehicles (AGV).
